(19) United States
(12) Patent Application Publication
(10) Pub. No.: US 2009/0300554 A1
(43) Pub. Date: Dec. 3, 2009

(54) Gesture Recognition for Display Zoom Feature

(75) Inventor: Otso Kallinen, Turku (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/131,976

(22) Filed: Jun. 3, 2008

(51) Int. Cl. G06F 3/033

(52) U.S. Cl. 715/863

(57) ABSTRACT

A method, apparatus, and system are disclosed that provide a computing user with an ability to engage in a multitude of operations via the entry of gestures. Computer operations may be mapped to shapes, and a comparison may take place between a user-entered gesture and the shapes to determine whether the gesture approximates at least one of the shapes. Responsive to determining that the gesture approximates at least one of the shapes, an operation associated with the shape may be executed. The operation may include a zoom operation (e.g., a zoom-in or a zoom-out operation), wherein the dimensions of the gesture may influence content to be included in an updated display. Additional adjustments may be performed to improve a resolution associated with the content included in the updated display.

### FIELD

Aspects of the invention generally relate to mobile computing technologies and technologies having limited display areas used to provide visual information. More specifically, an apparatus, method and system are described for providing a zoom feature in a data processing apparatus having limited screen area, based on one or more of a path recognition, vectorisation, and tangent point calculation.

### BACKGROUND

Improvements in computing technologies have changed the way people accomplish various tasks. For example, people frequently schedule activities using an electronic calendar. The electronic calendar may be configured to provide a user with a comprehensive view of scheduled activities in a given day. For example, the comprehensive view may present a grid of twenty-four (24) rows or slots corresponding to each hour in a given day, and if the user has an activity planned in any given hour, the associated row or slot may be shaded a particular color to serve as a reminder to the user that an activity is scheduled to take place at that time. In this manner, the user can obtain from the comprehensive view an overall sense of how busy her day will be, and when she may have some free-time to squeeze-in additional activities that arose at the last minute.

In order to obtain visibility into a scheduled activity in a given time slot, a user may have to zoom-in from the comprehensive view to the time slot to be able to see the details. For example, if a display screen is relatively small in size (as is frequently the case with respect to mobile devices), it might not be possible to simultaneously display both a comprehensive view and detailed information related to scheduled activities.

### BRIEF SUMMARY

The following presents a simplified summary of aspects of the invention in order to provide a basic understanding of some aspects of the invention. This summary is not an extensive overview, and is not intended to identify key or critical elements or to delineate the scope of the claims. The following summary merely presents some concepts and aspects of the invention in a simplified form as a prelude to the more detailed description provided below.

To overcome limitations in the prior art described above, and to overcome other limitations that will be apparent upon reading and understanding the present specification, aspects of the present invention are directed to an apparatus, method and system for providing a simple and intuitive way to zoom via one or more computer platforms. More specifically, a user may select one or more visual elements or areas on a display screen via one or more circular or oval gestures. In response to the one or more gestures, a zoom operation may take place to zoom-in on the one or more visual elements or areas.

Various aspects of the invention may, alone or in combination with each other, provide for receiving at a computing device one or more user gestures, determining whether the gestures form a closed path, calculating tangent points, and determining whether the gestures approximate a geometrical shape. Other various aspects of the invention may, alone or in combination with each other, provide for determining whether a gesture has been received within a specified time window so as to be representative of a command.

These and other aspects of the invention generally relate to a user indicating an interest in zooming-in on one or more elements or areas of a display screen. A user may draw a circle onto a display screen using a counter clockwise oriented gesture. The circle may define a zoom-in area, and contents or information presented on the display screen may be updated, refreshed, or redrawn so as exclude those contents, information, or areas that are outside of the circle. Thereafter, a zoom-out operation may take place responsive to the user drawing a circle via a clockwise oriented gesture.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a data processing architecture suitable for carrying out one or more illustrative aspects of the invention.

FIG. 2 illustrates a flow chart depicting a method suitable for carrying out one or more aspects of the invention.

FIGS. 3 through 8 illustrate various use case scenarios wherein one or more illustrative aspects of the invention may be practiced.

### DETAILED DESCRIPTION

In the following description of the various embodiments, reference is made to the accompanying drawings, which form a part hereof, and in which is shown by way of illustration various embodiments in which one or more aspects of the invention may be practiced. It is to be understood that other embodiments may be utilized and structural and functional modifications may be made without departing from the scope of the present invention.

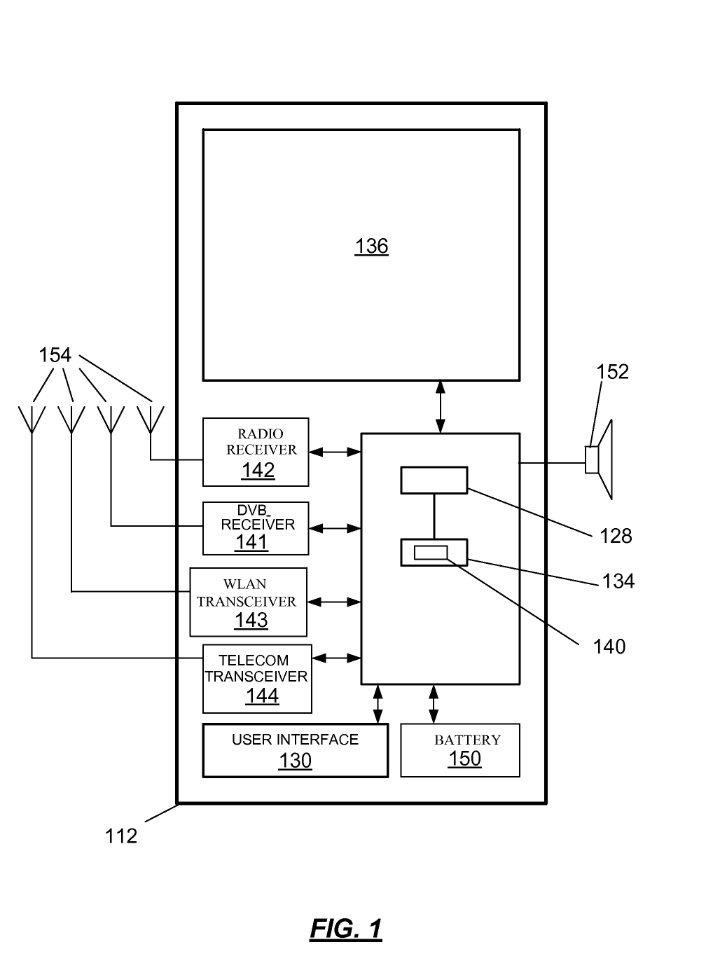

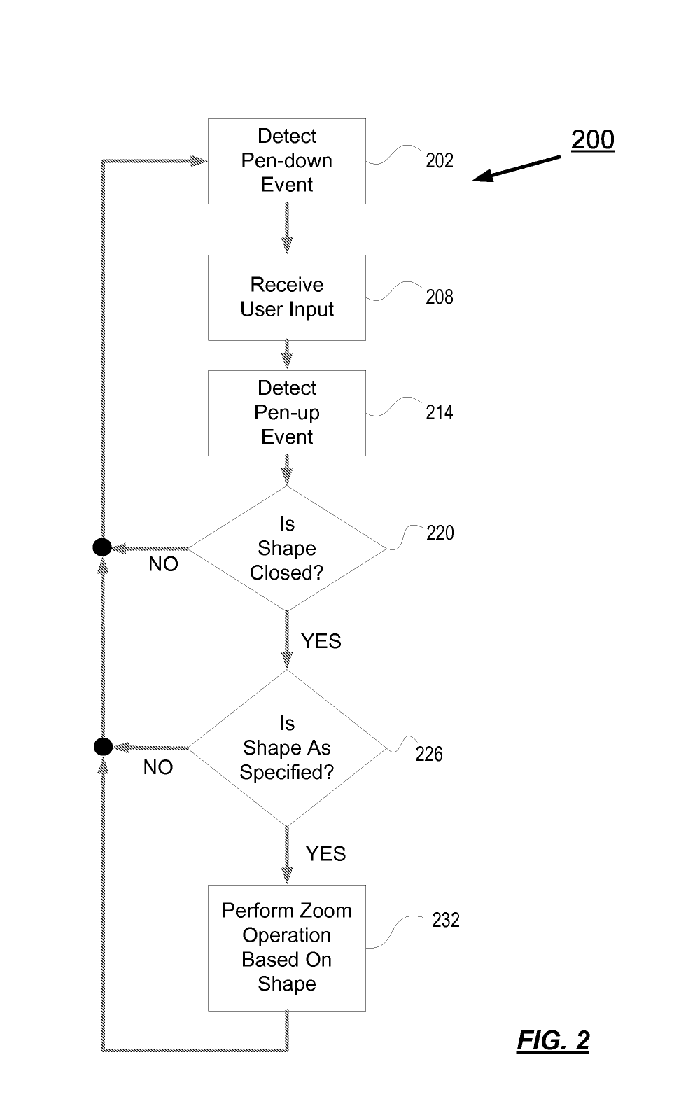

FIG. 1 illustrates a generic computing device 112, e.g., a desktop computer, laptop computer, notebook computer, network server, portable computing device, personal digital assistant, smart phone, mobile telephone, cellular telephone (cell phone), terminal, distributed computing network device, mobile media device, or any other device having the requisite components or abilities to operate as described herein. As shown in FIG. 1, device 112 may include processor 128 connected to user interface 130, memory 134 and/or other storage, and display screen 136. Device 112 may also include battery 150, speaker 152 and antennas 154. User interface 130 may further include a keypad, touch screen, voice interface, four arrow keys, joy-stick, stylus, data glove, mouse, roller ball, touch screen, or the like. In addition, user interface 130 may include the entirety of or portion of display screen 136.

Computer executable instructions and data used by processor 128 and other components within device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling device 112 to perform various functions. Alternatively, some or all of the computer executable instructions may be embodied in hardware or firmware (not shown).

Furthermore, computing device 112 may include additional hardware, software and/or firmware to support one or more aspects of the invention as described herein. For example, computing device 112 may include audiovisual support software/firmware. Device 112 may be configured to receive, decode and process digital broadband broadcast transmissions that are based, for example, on the Digital Video Broadcast (DVB) standard, such as DVB-H, DVB-T or DVB-MHP, through a specific DVB receiver 141. Digital Audio Broadcasting/Digital Multimedia Broadcasting (DAB/DMB) may also be used to convey television, video, radio, and data. Device 112 may also include other types of receivers for digital broadband broadcast transmissions. Additionally, device 112 may be configured to receive, decode and process transmissions through FM/AM Radio receiver 142, WLAN transceiver 143, and telecommunications transceiver 144. In some embodiments, device 112 may receive radio data stream (RDS) messages.

Device 112 may use computer program product implementations including a series of computer instructions fixed either on a tangible medium, such as a computer readable storage medium (e.g., a diskette, CD-ROM, ROM, DVD, fixed disk, etc.) or transmittable to computer device 112, via a modem or other interface device, such as a communications adapter connected to a network over a medium, which is either tangible (e.g., optical or analog communication lines) or implemented wirelessly (e.g., microwave, infrared, radio, or other transmission techniques). The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device (e.g., memory 134), such as a semiconductor, magnetic, optical, or other memory device, and may be transmitted using any communications technology, such as optical infrared, microwave, or other transmission technology. Such a computer program product may be distributed as a removable storage medium with accompanying printed or electronic documentation (e.g., shrink wrapped software), preloaded with a computer system (e.g., on system ROM or fixed disk), or distributed from a server or electronic bulletin board over a network (e.g., the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be divided between multiple computing entities.

Device 112 may communicate with one or more devices or servers over Wi-Fi, GSM, 3G, WiMax, or other types of wired and/or wireless connections. Mobile and non-mobile operating systems (OS) may be used, such as Windows Mobile®, Palm® OS, Windows Vista® and the like. Other mobile and non-mobile devices and/or operating systems may also be used.

By way of introduction, aspects of the invention provide a computer user an ability to easily zoom-in on (and zoom-out from) elements or areas of displayed content for purposes of refining a focus within a display screen (e.g., display screen 136). The user may enter one or more inputs into a computing device (e.g., device 112). The one or more inputs may include inputting gestures in the form of one or more shapes, such as a circle, oval, ellipse, or the like, using a display screen (e.g., display screen 136) of a computing device (e.g., device 112). Upon receiving the one or more inputs, the computing device may determine if the inputs conform to a specified shape (e.g., a closed circle or loop meeting predefined criteria, discussed below). After determining that the inputs conform to the specified shape, the information presented on the display screen may be updated or refreshed to reflect the content enclosed by the specified shape. Thereafter, the computing device may monitor one or more input devices (e.g., display screen 136) to determine if the user has input a command (e.g., a zoom-out command) directing the computing device to once again resize the contents shown on the display screen; the command may take the form of a user drawing a circle on the display screen in a counter clockwise direction. The user may also input multiple zoom-in and/or zoom-out gestures consecutively, without the need to reset the zoom level between operations.

FIG. 2 illustrates a flow chart describing a method 200 suitable for carrying out one or more aspects of the invention as described herein. Method 200 may be executed on any suitable computing platform (e.g., computing device 112 of FIG. 1). More specifically, method 200 may be executed in or by a software application, via a client/server architecture, through Java, Java Script, AJAX, applet, Flash®, Silverlight™, other applications, operating systems, programming languages, devices and the like.

In step 202, a computing device (e.g., device 112) may detect receipt of a pen-down event. For example, a user may begin entering a gesture into a touch-sensitive display screen (e.g., display screen 136) using a stylus, electronic pen, one's finger, or the like, and the display screen may be configured to determine when contact with the display screen has been initiated, using any touch sensing technique, now known or later developed.

In step 208, the computing device may receive the gesture as user input by way of the touch-sensitive display screen. The user input may correspond to one or more commands, such as a zoom command as described below. The user input may be stored in one or more memory devices (e.g., memory 134 of FIG. 1) as a data vector at the computing device (e.g., device 112). Alternatively, or additionally, the user input may be transmitted to another device (e.g., a server) as a data vector using one or more communication protocols. This latter option of transmitting the data vector to another device may be desirable when the computing device is configured with a limited storage capacity, when the computing device has limited processing resources, or when the computing device is executing other (higher priority) tasks.

In step 214, the computing device may detect receipt of a pen-up event, which may serve as an indication that the user has completed entering a gesture. In order to avoid premature termination of the receipt of user input (pursuant to step 208) when a user has inadvertently broken contact with the display screen, the computing device may operate in conjunction with a timer or the like in step 214 during which the computing device or display screen may check to see if contact with the display screen remains broken for a timeout threshold before determining the broken contact to indicate a pen-up event. Alternatively, a user may push a button or key (e.g., as part of user interface 130 of FIG. 1), select a command from a drop-down menu or the like to confirm completion of the one or more gestures.

In step 220, the computing device may process the user input received (and stored) in step 208 to determine if the user input corresponds to a predefined shape indicating a zoom event, e.g., a closed loop shape. For example, if the zoom commands as described more fully below correspond to receiving a user-entered gesture in the form of a circle, step 220 may be related to determining whether the input corresponds to a closed circle. A closed circle may be defined by a beginning point (e.g., denoted by a point on the display screen where the pen-down event was received in step 202) and an end point (e.g., denoted by a point on the display screen where the pen-up event was received in step 214) corresponding to approximately the same point, and includes any generally circular shape such as a circle, ellipse, oval, egg-shape, etc. If the beginning point and the end point are not approximately the same point, then the shape might not be considered a closed shape (“NO” out of diamond 220), and execution may be returned to step 202, wherein the computing device monitors for receipt of a pen-down event. Otherwise, when the beginning point and the end point are approximately the same point, then the shape is considered to be a closed shape (“YES” out of diamond 220), and execution flows to step 226.

In step 226, a determination may be made whether the (closed) shape meets additional criteria. For example, in the context of a circular shape corresponding to one or more zoom commands as described below, the user input might not (and in most scenarios, frequently will not) correspond to a perfectly circular shape, but instead may be characterized by a number or degree of turns or tangents as more fully described below in conjunction with FIG. 5. In the context of a rectangular shaped gesture, which in some embodiments may serve as a zoom command instead of, or in addition to, a circular shaped gesture, step 226 may correspond to determining whether the corners of the rectangular gesture approximate right angles (e.g., ninety (90) degrees) and whether the line segments connecting the corners are approximately straight. Accordingly, in step 226, the geometry of a user-entered gesture received via step 208 may be analyzed to determine if it approximates one or more expected shapes. If the criteria in step 226 is not satisfied (“NO” out of diamond 226), execution returns to step 202, wherein the computing device monitors for receipt of a pen-down event. Otherwise, if the criteria in step 226 is satisfied (“YES” out of diamond 226), execution flows to step 232.

One of skill in the art will appreciate that one or both of steps 220 and 226 may be used to process the user input received in step 208. In the embodiments described above in conjunction with step 208, wherein the computing device transmits the user input as a data vector to another device (e.g., a server), the computing device may request the another device to return the data vector in a staged manner. For example, in embodiments where the computing device is configured with limited storage capacity, the computing device may iteratively receive portions of the data vector from the another device, and may process those portions of the data vector via steps 220 and 226 until a determination is made that the user input does not satisfy the conditions of steps 220 and 226 or until the data vector has been (completely) processed. Alternatively, in some embodiments the another device may be configured to perform the processing associated with steps 220 and 226, and the computing device may receive from the another device a message indicating a pass/fail status, an operation to perform (if any), or the like.

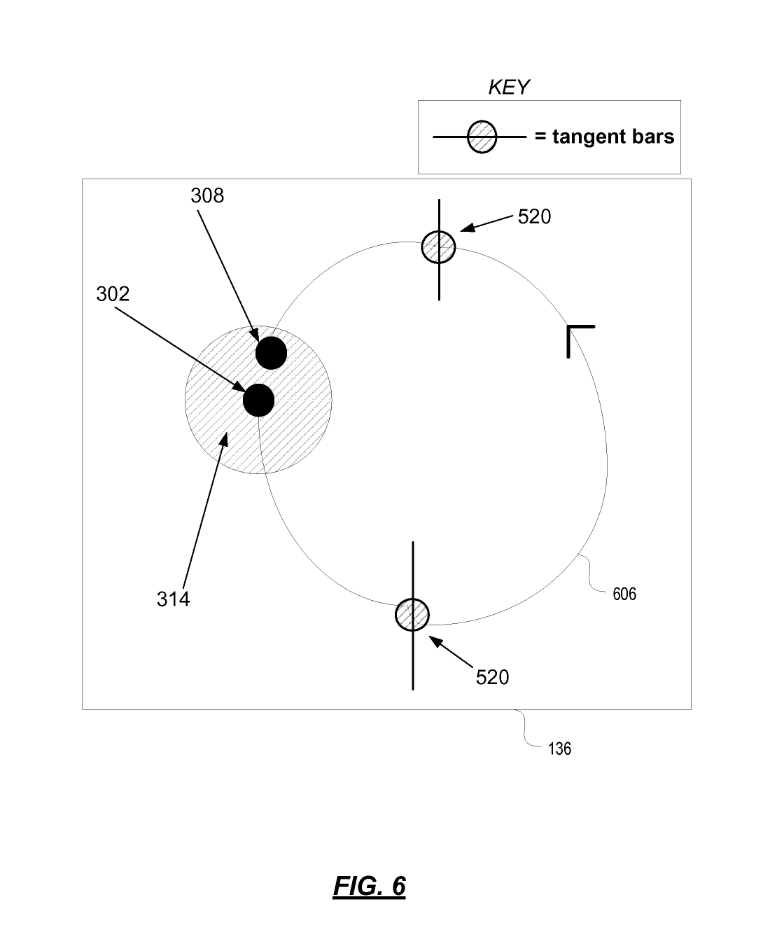

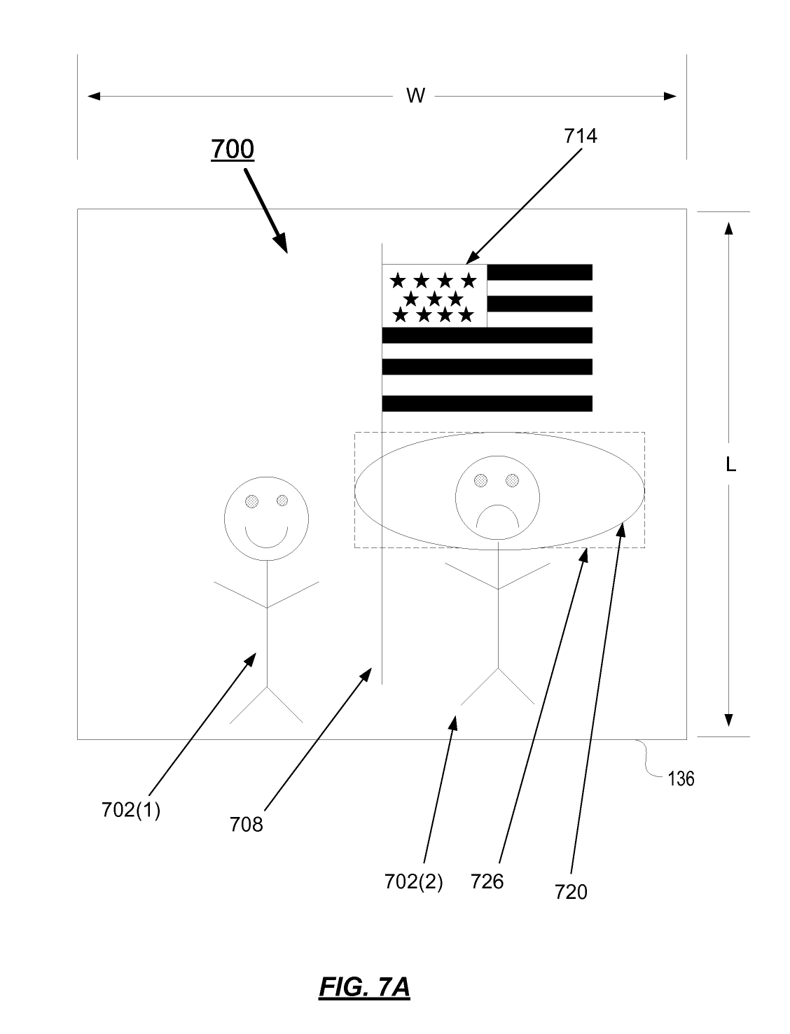

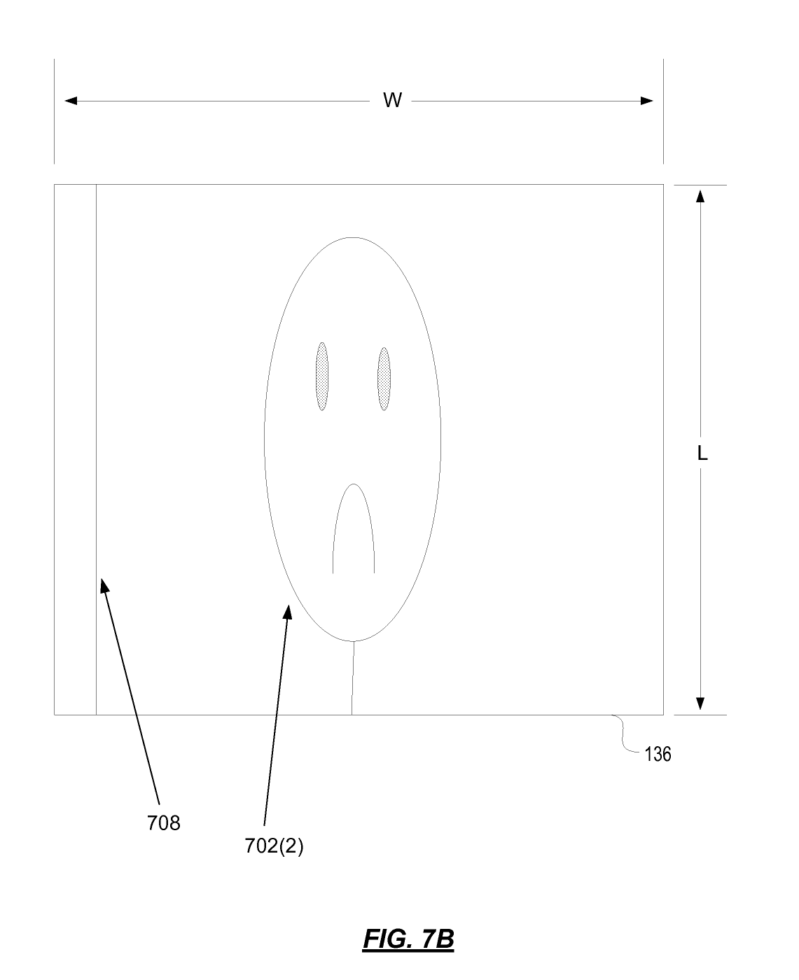

In step 232, an operation may be performed based on the shape determined in step 226. For example, in some embodiments, when a user performs a gesture by drawing (using a finger, an electronic-pen, a stylus, or the like) a circle on a display screen of a computing device, the circle may be associated with a zoom-in operation, wherein the area enclosed by the circle may define an outer boundary of the area to be presented in a refreshed display once the zoom-in operation takes place. Curve fitting operations or the like may be performed to complete a drawn circle if it is approximately closed, but not completely closed. Alternatively, or additionally, after receiving a successful circular gesture (e.g., like the gesture demonstrated in FIG. 6 described below), a rectangle may be imposed around the circle, with the rectangle fitted to the geometry of the display screen such that a usable area of the display screen is maximized. Additional adjustments may be performed to ensure that a resolution in the updated display screen is rational. For example, an adjustment providing a rational resolution may entail selecting a best-fit resolution from a pool of candidate resolutions. As the rectangle and the display screen may frequently have different proportions, extra area may be selected for display based on where there is the most informational content available. For example, if a user selects a zoom area outside a (browser) window on a right hand side, an extra area to be included in the updated display may be taken from the left hand side that contains (pixel) information, in order to maximize the information presented in the updated display.

Additional criteria may be imposed to differentiate between various operations, or stated another way, to increase the number of operations that may be performed responsive to user-entered gestures. For example, in order for a zoom-in operation to take place, in addition to drawing a circle a user may also be required to draw the circle in a counter clockwise direction. Conversely, a user may initiate a zoom-out operation by drawing a circle in a clockwise direction. In some embodiments, the directions may be reversed (e.g., a zoom-in operation may correspond to a clockwise oriented gesture, and a zoom-out operation may correspond to a counter clockwise oriented gesture), and the directions may be user-configurable.

A panning operation may be supported by a number of embodiments, wherein a user can direct a canvas associated with display screen 136 to move or scroll in one or more directions via a pen-down/stroke/pen-up sequence. It is recognized, however, that an issue may arise attempting to distinguish a panning operation from a zoom operation when a user is attempting a panning operation (for example) via a relatively circular gesture. There are various criteria that may be used to distinguish a (circular) panning operation from a zoom command. For example, in some embodiments, a user may be required to hold a stylus, electronic pen, one's finger, or the like used to form a gesture stationary for or within a time threshold before beginning a panning and/or zooming operation. In some embodiments, a user may be required to apply a certain level of pressure before a panning operation is recognized. In some embodiments, acceleration associated with the stylus, electronic pen, one's finger, or the like used to form the gesture may be measured immediately following a pen-down event wherein if the measured acceleration exceeds a threshold, computing device 112 may be configured to recognize a panning operation. In some embodiments, a curvature associated with a gesture may be measured at the beginning of the gesture, and a decision as to whether the gesture corresponds to a panning operation or a zoom operation may be made; panning strokes may be generally straight whereas gestures associated with a zoom operation may be characterized by a greater degree of curvature. Other criteria may be used to distinguish a panning operation from a zoom operation, and a user may have an opportunity to customize the criteria in some embodiments.

Optionally, a degree of zooming-out may be responsive to the size of the drawn clockwise circle. For example, if a user draws a relatively small clockwise circle on the display screen, the degree of zooming-out may be relatively small. On the other hand, if the user draws a relatively large clockwise circle on the display screen, the degree of zooming-out may be relatively large, or vice-versa. Alternatively, in some embodiments the degree of zooming-out may be insensitive to the size of the drawn clockwise circle. For example, responsive to a drawn clockwise circle of any size, the computing device may restore the contents shown in the display screen to a state just before a previous zoom-in operation, a default display setting, or the like.

One of skill in the art will appreciate that method 200 is merely illustrative, that some steps may be optional in some embodiments, that steps may be interchanged, and that additional steps not shown may be inserted, without departing from the scope and spirit of the illustrated method. For example, steps 220 (checking for shape closure) and 226 (checking for shape criteria/specifics) may be interchanged while effectively achieving the same results. Additionally, steps 208, 220, and 226 may be incorporated as part of an iterative loop, with step 214 following thereafter, such that user input that is received is processed immediately (thereby potentially eliminating a need to store the user input received at step 208); instead, a status may be saved as to whether any particular processing operation on the received user input was successful, or the loop may be exited once it is determined that a portion of the user input fails to adhere to established criteria.

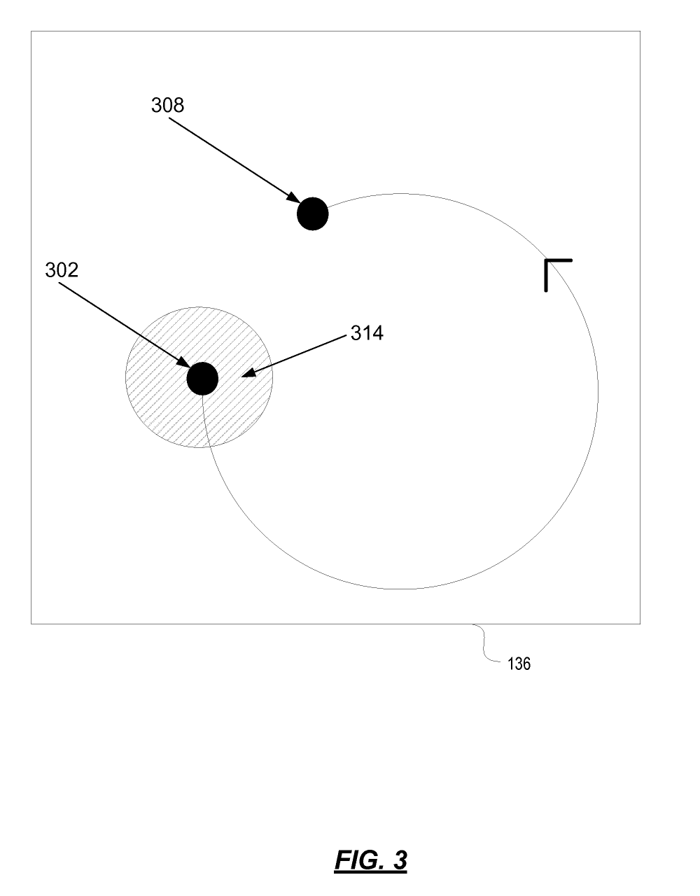

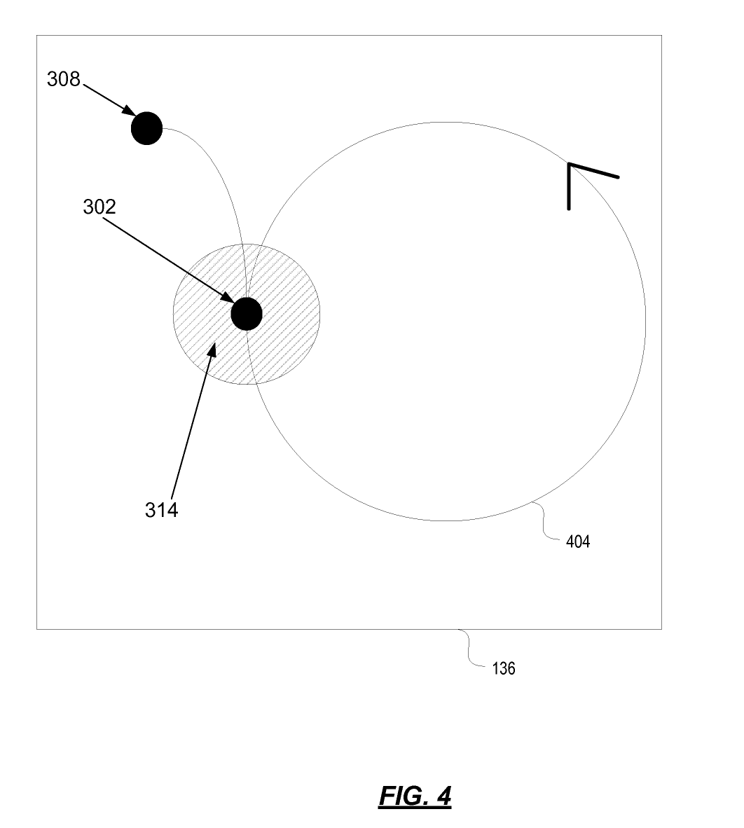

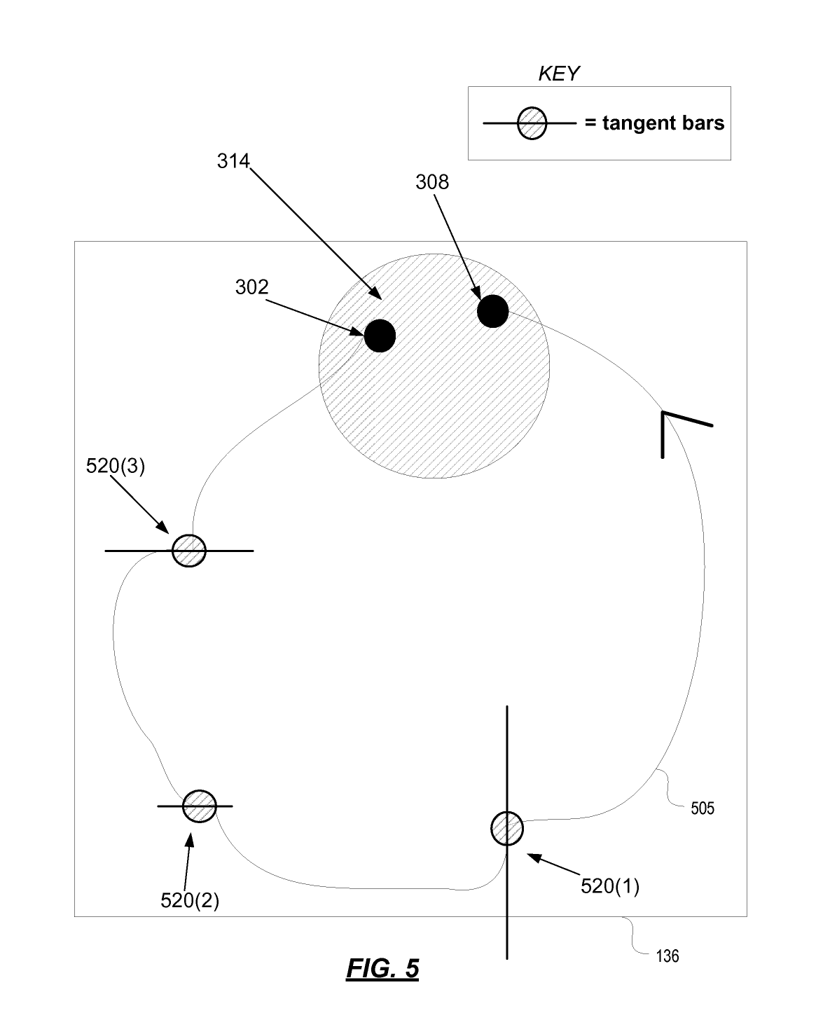

FIGS. 3-6 illustrate various use case scenarios that demonstrate one or more illustrative aspects of the invention. The examples shown in FIGS. 3-6 serve to demonstrate that a user may engage in any number of gestures while using any number of programs, applications or the like on a computing device. Accordingly, in some embodiments it may be desirable to impose one or more criteria in order to differentiate the various gestures, or to differentiate a valid gesture from an invalid gesture.

In FIG. 3, a gesture is demonstrated wherein a user has engaged in a pen-down event (e.g., pen-down event 202 of FIG. 2) at a beginning point 302 and has proceeded to draw a portion of a circle in a counter clockwise manner until ending the gesture (e.g., via a pen-up event 214 of FIG. 2) at an end point 308 on a touch sensitive display screen, e.g., display screen 136. End zone area 314 shown in FIG. 3 may serve to define a region wherein beginning point 302 and end point 308 are approximated to be the same point when both beginning point 302 and end point 308 lie within area 314 (e.g., in accordance with the determination performed in step 220 of FIG. 2). That is, area 314 is determined based on beginning point 302, and if end point 308 is determined to be within area 314, then the gesture is considered to be a closed shape in step 220. As shown in FIG. 3, beginning point 302 is centered within area 314, however, end point 308 lies outside of area 314. As such, in the example of FIG. 3, beginning point 302 and end point 308 are not considered to be the same point (e.g., the “NO” path out of diamond 220 of FIG. 2 is taken), and an operation (e.g., a zoom-in operation pursuant to step 232 of FIG. 2) is not performed.

As shown in FIG. 3, beginning point 302 serves as the center of area 314. It is understood that end point 308 may instead serve as the center of area 314. For example, as a user is drawing a gesture on the display screen, area 314 may move with the instrument (e.g., the stylus, electronic pen, one's finger, or the like) used to perform the gesture, with the instrument serving as a center-point of (moving) area 314. Area 314 may optionally be visually rendered on a display device once a user has completed a portion (e.g., 75%) of a gesture in order to provide the user with guidance as to where to place the end point 308 (e.g., where to terminate the gesture via a pen-up event pursuant to step 214 of FIG. 2). In this manner, a user may obtain a sense of where an end-point 308 would be placed relative to a beginning point 302, as reflected by whether both points lie within area 314.

It is recognized that area 314 serves as a measure of distance between beginning point 302 and end point 308. As such, area 314 may be configured in such a way as to attempt to maximize the likelihood that beginning point 302 and end point 308 both lie within area 314. One or more resolution schemes may be implemented to resolve the situation when at least one of beginning point 302 and end point 308 lie on the perimeter of area 314 (and thus, where it is unclear whether both beginning point 302 and end point 308 lie within area 314). For example, a resolution scheme may reject a gesture when at least one of beginning point 302 and end point 308 touch the perimeter of area 314. Additional resolution schemes may be implemented. Area 314 may be of any desired size that effects the closed loop gesture input technique described herein.

Area 314 may also be configured to support a zoom-out operation. For example, area 314 may be left on a display screen in a semi-transparent state once a user successfully performs a complete gesture (an example of a complete gesture is demonstrated in accordance with FIG. 6 described below), with a “back-button” or the like to effectuate a zoom-out operation when depressed.

Area 314 is shown in FIG. 3 as a circle. It is understood that area 314 may be implemented using alternative shapes, and may be alternative sizes.

FIG. 4 demonstrates the entry of a complete counter clockwise circular gesture 404 with respect to beginning point 302. But, in FIG. 4, end point 308 (which may be denoted by a pen-up event as per step 214 of FIG. 2) is located at a point on a display screen that lies outside of area 314. As such, an operation (e.g., a zoom-in operation pursuant to step 232 of FIG. 2) is not performed because the gesture is not considered to be a closed shape (e.g., in accordance with step 220 of FIG. 2).

In FIG. 5, a closed, counter clockwise gesture 505 has been entered, such that beginning point 302 and end point 308 both lie within area 314. However, the gesture is characterized by an excessive number of turns (e.g., three turns), denoted by tangent bars 520(1)-520-(3), that preclude terming the entered gesture a “circle” (e.g., the “NO” path is taken out of diamond 226 of FIG. 2). Tangent bars 520 represent points in a vector path where the direction of the path is measured as having changed from a first general direction (e.g., substantially along an x-axis or arcing in a first direction) to a second general direction (e.g., substantially along a y-axis or arcing in a second direction). As such, an operation (e.g., a zoom-in operation pursuant to step 232 of FIG. 2) is not performed because the gesture is not considered to be a circle (or more generally, because the entered gesture does not approximate any expected shape or the expected gesture of a user desiring to zoom in on a particular area or region). In some embodiments in addition to the number of turns denoted by tangent bars 520, an excessive degree of change associated with any particular tangent bar 520 may be enough to render the entered gesture an invalid shape. For example, tangent bar 520(1) may be so (relatively) egregious as to render the entered gesture invalid even if the remainder of an entered gesture is “perfect.” Accordingly, in some embodiments a balancing or trade-off may take place between the number of tangent bars 520 and the degree to which any tangent bar 520 deviates from an ideal shape in determining whether the entered gesture is close enough to the ideal shape so as to constitute a valid gesture. More generally, the number of tangent bars 520 and a degree of deviation associated with each tangent bar 520 may be compared against a threshold to determine whether a shape sufficiently approximates an expected shape.

FIG. 6 demonstrates a successful, intentional zoom gesture 606. More specifically, beginning point 302 and end point 308 lie within area 314, and the counter clockwise circular gesture exhibits a relatively limited number of tangent bars 520, none of which are particularly egregious. Accordingly, an operation (e.g., a zoom-in operation pursuant to step 232 of FIG. 2) may take place with the area enclosed by the circular gesture serving to define the region to be shown in an updated display screen.

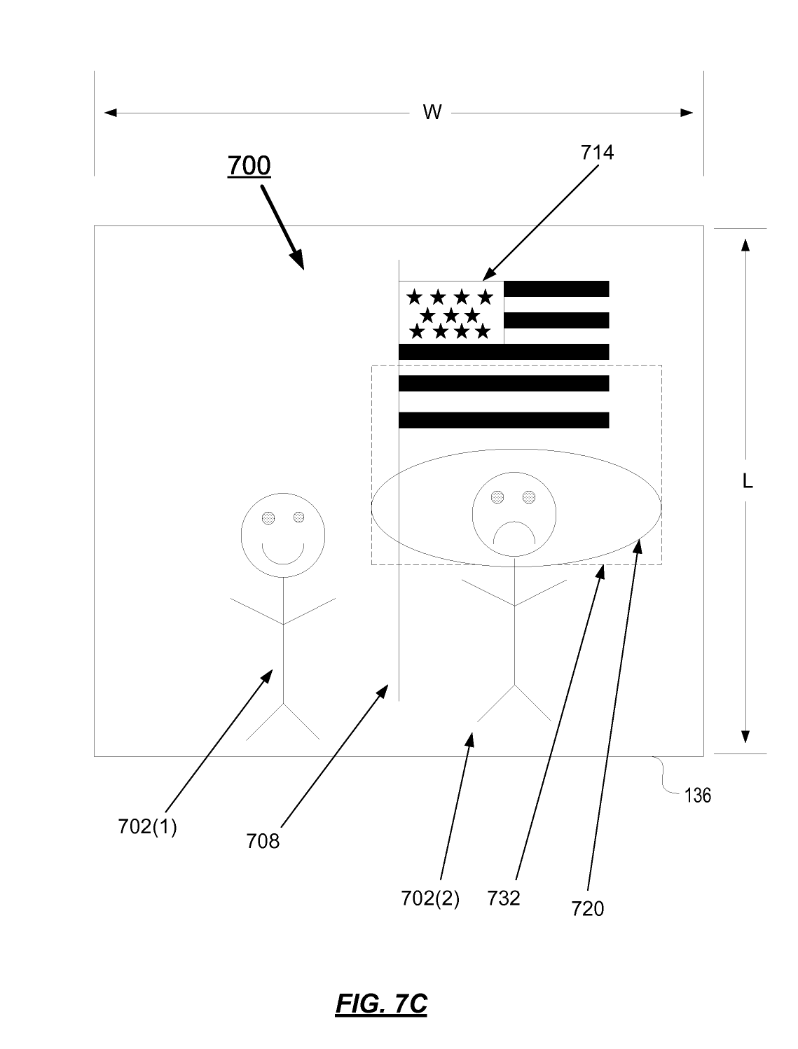

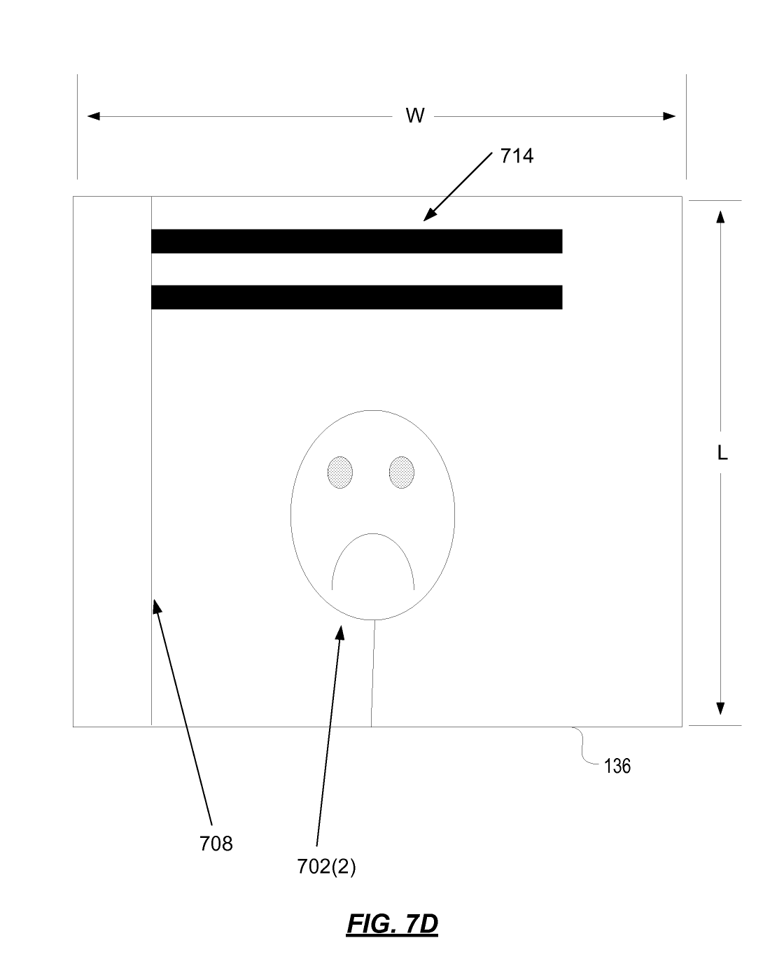

A circular gesture has been described as serving to define a region to be shown in an updated display screen following a zoom(-in) operation. In some embodiments, additional steps may be taken to refine what is shown in the updated display screen as described above with respect to FIG. 2. For example, FIG. 7A illustrates a scenario 700 wherein two people, 702(1) and 702(2), are displayed on display screen 136 standing alongside a flagpole 708 from which a flag 714 is hanging. A user viewing the display screen may believe that person 702(2) is her friend, and desiring to obtain a closer view of person 702(2)'s facial features, may enter an oval gesture 720 substantially over person 702(2)'s head, wherein oval gesture 720 corresponds to a zoom-in command according to an aspect of the invention described herein. Thereafter, a processor (e.g., processor 128 of FIG. 1) connected to or integrated with display screen 136 may recognize gesture 720 as a zoom-in command. Responsive to recognizing the zoom-in command, the processor may determine a rectangle 726 appropriate for bounding gesture 720 based on the upper, lower, right and left edges of gesture 720. Rectangle 726 may be rendered on display screen 136, or rectangle 726 might not be rendered on display screen 136 but instead may simply be a logical, theoretical, or conceptual rectangle (e.g., a phantom rectangle) imposed as part of one or more processing algorithms, functions or the like.

FIG. 7B illustrates the results after a zoom-in command has been executed responsive to entered gesture 720 and processing associated with rectangle 726. In FIG. 7B, in addition to including a portion of flagpole 708 captured within rectangle 726, person 702(2)'s head in the zoomed-in view has been stretched to fill the entirety of display screen 136. Because gesture 720 was initially drawn (in FIG. 7A) as an elongated oval that consumed proportionally more of a width (W) of display screen 136 than a length (L) of display screen 136, the degree of stretching in the length (L) direction was greater than the degree of stretching in the width (W) direction in the updated display screen 136 shown in FIG. 7B. As a result, person 702(2)'s head is shown as disproportionately elongated in the length (L) direction in FIG. 7B. As such, and as shown in FIGS. 7A and 7B, after receiving a successful gesture 720 corresponding to a zoom-in command, rectangle 726 may be drawn or imposed around gesture 720, with the rectangle fitted (e.g., stretched in one or more directions) to the geometry of the display screen such that a usable area of the display screen is maximized.

In some embodiments, the resulting elongation (as illustrated with respect to person 702(2)'s head in FIG. 7B) may be unacceptable. As a result, additional adjustments may be performed to ensure that a rendered image in the updated display screen is rational. For example, an adjustment providing a rational rendered image may entail selecting a best-fit rendered image from a pool of candidate rendered images. As described above with respect to FIGS. 7A and 7B, rectangle 726 and display screen 136 may frequently have different proportions resulting in elongation in an updated display. Accordingly, and in order to account for such effects, extra area may be selected for display. For example, as shown in FIG. 7C, rectangle 732 has been drawn around gesture 720 (in place of, as a refinement to, or in addition to rectangle 726 (not shown in FIG. 7C)) in such a manner that rectangle 732 more closely approximates a proportionately scaled-down version of the display screen 136 in terms of display screen 136's ratio, geometry or dimensions (e.g., length (L) and width (W)). As such, in addition to rendering in an updated display screen 136 person 702(2)'s head and a portion of flag pole 708, the updated display screen 136 in FIG. 7D includes a portion of flag 714 bounded by rectangle 732. A comparison of FIGS. 7B and 7D reflects a proportionately more accurate rendering of person 702(2)'s head in FIG. 7D, based on the extra area above gesture 720 bounded by rectangle 732 in comparison to rectangle 726. This may result in the user of display screen 136 more readily being able to determine whether person 702(2) is indeed her friend.

Rectangle 732 is illustrated in FIG. 7C as growing up or towards the top of display screen 136 (which resulted in a portion of flag 714 being included in the updated display screen 136 shown in FIG. 7D) relative to rectangle 726. The selection of in which direction(s) to locate the extra area associated with rectangle 732 may be based on where there is the most informational content available. Any number of measurements may be conducted to determine where the greatest amount of informational content is available. For example, a gradient may be measured with respect to a number of pixels to determine where the greatest degree of change is present in a rendered image. In the context of the images shown in FIGS. 7A-7D, flag 714 represents a relatively large gradient due to the changing color characteristics of the stripes associated with flag 714 over relatively small distances. Additional techniques may be implemented in selecting the size or positioning of rectangle 732. For example, in some embodiments, rectangle 732 may be configured in such a way that a center-position of gesture 720 lies at a center-point of rectangle 732. In other embodiments facial recognition may be used to identify a person within the zoomed in area, and as much of the person as possible is included within the zoomed view.

In some embodiments, rectangle 732 may be configured based on a comparison between the selected zoom area (bounded by rectangle 726) and source code (e.g., HTML source code). For example, if a user input zoom area identified by rectangle 726 covers a portion of an entity (e.g., the face of person 702(2)), the underlying source code may be examined to determine a logical entity most closely related to the covered portion. As such, rectangle 732 in the illustration of FIG. 7D may be configured to grow downward or towards the bottom of display screen 136 so as to include more of person 702(2)'s neck and torso in a zoomed-in displayed screen because person 702(2)'s neck and torso are more closely related to person 702(2)'s head then flag 714.

As discussed above, rectangle 726 (and rectangle 732) may be drawn on display screen 136. In some embodiments, a user may have an opportunity to adjust a dimension of rectangle 726 or rectangle 732. For example, rectangle 726 and rectangle 732 may represent a default rectangle, and a user may have an opportunity to adjust the size of or location of the default rectangle. A timer may also be implemented, such that if a user does not take any action with respect to the default rectangle within a timeout period, the default rectangle may be used for purposes of rendering the updated display.

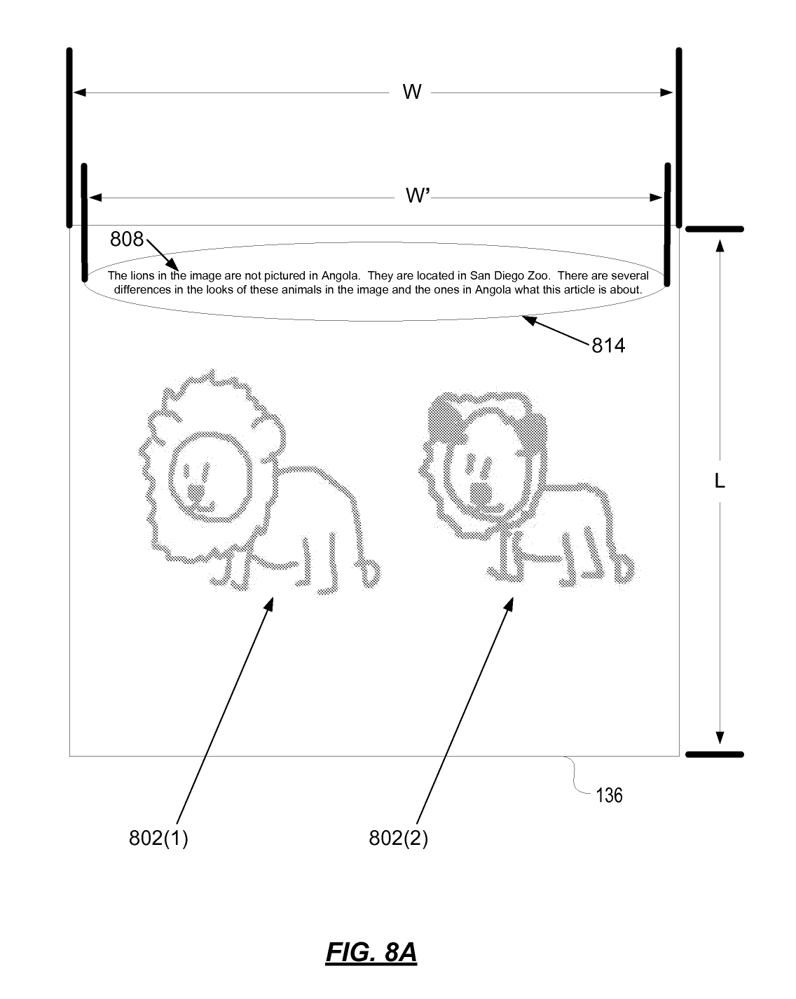

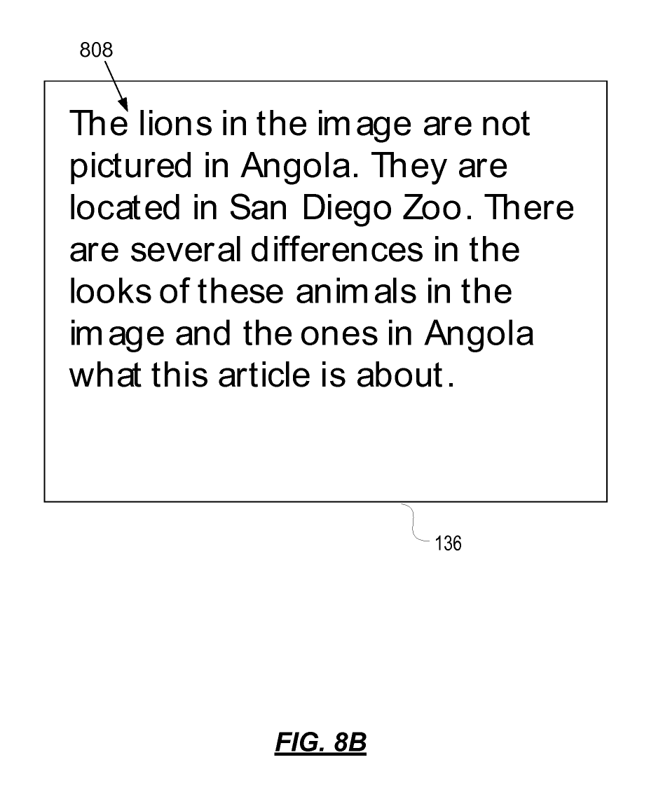

In FIG. 8A, two lions (802(1) and 802(2)) are illustrated in a display screen 136 as part of a magazine article. Also included in the article is a textual description 808 related to the illustrated lions 802(1) and 802(2). In FIG. 8A, a user has drawn a successful gesture 814 onto display screen 136 corresponding to a zoom-in command in order to magnify the small print of textual description 808. In the example shown in FIG. 8A, however, gesture 814 has approximately the same width (W′) as the width (W) of display screen 136. As such, there might not be an appreciable difference in zoom-level, thus offering little benefit to a user unable to read textual description 808 due to the relatively small print. In some embodiments, the zoom feature may use (HTML) information or the like from a browser, application window, etc. to detect that the area bounded by gesture 814 is text. After recognition that the bounded area is text, textual description 808 may be copied to memory (e.g., memory 134 of FIG. 1) and may be re-arranged or re-scaled for improved readability on display screen 136 as illustrated in FIG. 8B.

The foregoing description has imposed criteria on a gesture largely based on spatial characteristics associated with the gesture. It is recognized that additional criteria may be imposed before a gesture is deemed valid. For example, temporal criteria may be imposed on a gesture. More specifically, in some embodiments a gesture is not recognized if it occurs within a time threshold (e.g., 3 seconds) of a previous gesture. Alternatively, or additionally, a timing requirement may be imposed with respect to the entry of a particular gesture. For example, if the time it takes from the beginning of a gesture (e.g., denoted by a pen-down event pursuant to step 202 of FIG. 2) until the end of the gesture (e.g., denoted by a pen-up event pursuant to step 214 of FIG. 2) exceeds a threshold (e.g., 5 seconds), the gesture may be deemed invalid.

The various criteria used to validate a gesture may be implemented on a computing device at the time it is fabricated, and may be applied irrespective of the identity of a user using the computing device. The computing device may also support a training session, mode, or the like, wherein a user receives instruction as to how to correctly perform various gestures that the computing device will recognize. Alternatively, or additionally, a user may be able to override a set of default settings present in the computing device. For example, a user may be able to select from a number of options via a pull-down menu or the like, and may be able to download one or more packages or updates in an effort to customize gesture entry and validation (e.g., defining how many tangent bars may included within a valid gesture). Furthermore, the computing device may be configured to adapt to a user's gesture entries via one or more heuristic techniques, programs, or the like. As such, the computing device may be configured to support a log-in screen, user-entered password, personal identification number (PIN) or the like to distinguish one user from another and to allow the computing device to be used by a number of different users. These user-distinguishing features may also provide for a degree of security where the computing device performs a sensitive operation (e.g., firing a missile) responsive to an entered gesture.

Although the subject matter has been described in language specific to structural features and/or methodological acts, it is to be understood that the subject matter defined in the appended claims is not necessarily limited to the specific features or acts described above. For example, the description herein has largely referred to zoom-level operations based on circular gestures received at a computing device. One of skill in the art will appreciate that any number of commands, operations, and directives may be executed responsive to one or more gestures. As such, the specific features and acts described above are merely disclosed as example forms of implementing the claims.

1. A method comprising:
receiving a gesture on a display screen of a computing device;
determining that the gesture approximates a closed shape;
determining that a geometry of the gesture approximates an expected shape; and
responsive to determining that the gesture approximates a closed shape and that the geometry of the gesture approximates an expected shape, performing a zoom operation associated with the expected shape.

2. The method of claim 1, wherein the method further comprises:
detecting a pen-down event;
responsive to detecting the pen-down event, receiving the gesture on the display screen of the computing device as user input.

3. The method of claim 1, wherein the method further comprises:
detecting a pen-up event; and
responsive to detecting the pen-up event, performing the determining steps.

4. The method of claim 1, wherein the gesture approximates a circle drawn in a counter clockwise direction, and wherein the operation associated with the expected circle shape is a zoom-in operation.

5. The method of claim 1, wherein an area enclosed by the gesture defines an outer boundary of an area to be presented in a refreshed display.

6. The method of claim 1, wherein the gesture is drawn as a circle in a clockwise direction, and wherein the operation associated with the expected clockwise circle shape is a zoom-out operation.

7. The method of claim 6, wherein a degree of zoom-out associated with the zoom-out operation is based on a size of the gesture.

8. The method of claim 1, wherein the method further comprises:
receiving the gesture as user input;
storing the user input as a data vector at the computing device; and
performing said determining steps based on the stored data vector.

9. The method of claim 1, wherein the step of determining that the geometry of the gesture approximates an expected shape includes measuring tangents associated with the gesture and comparing the measured tangents against a threshold.

10. An apparatus comprising:
a display screen;
a processor; and
a memory configured to store computer readable instructions that, when executed by the processor, cause the apparatus to:
receive a gesture at the display screen;
determine that the gesture approximates a closed shape;
determine that a geometry of the gesture approximates an expected shape; and
responsive to determining that the gesture approximates a closed shape and that the geometry of the gesture approximates an expected shape, perform a zoom operation associated with the expected shape.

11. The apparatus of claim 10, wherein the gesture approximates a circle drawn in a counter clockwise direction, and wherein the operation associated with the expected circle shape is a zoom-in operation.

12. The apparatus of claim 10, wherein an area enclosed by the gesture defines an outer boundary of an area to be presented in a refreshed display.

13. The apparatus of claim 10, wherein the gesture is drawn as a circle in a clockwise direction, and wherein the operation associated with the expected clockwise circle shape is a zoom-out operation.

14. The apparatus of claim 10, wherein the computer readable instructions further include at least one instruction that, when executed by the processor, cause the apparatus to:
receive the gesture as user input;
store the user input as a data vector; and
perform said determining steps based on the stored data vector.

15. The apparatus of claim 10, wherein the computer readable instructions that, when executed by the processor, cause the apparatus to determine that the geometry of the gesture approximates an expected shape, further include instructions that, when executed, cause the apparatus to:
measure tangents associated with the gesture; and
compare the measured tangents against a threshold.

16. One or more computer readable media storing computer executable instructions that, when executed, perform an operation, comprising:
receiving a gesture;
determining that the gesture approximates a closed shape;
determining that a geometry of the gesture approximates an expected shape; and
responsive to determining that the gesture approximates a closed shape and that the geometry of the gesture approximates an expected shape, performing a zoom operation associated with the expected shape.

17. The one or more computer readable media of claim 16, wherein the received gesture approximates a circle drawn in a counter clockwise direction, and wherein the operation associated with the expected circle shape is a zoom-in operation.

18. The one or more computer readable media of claim 19, wherein the computer executable instructions that, when executed, cause the receipt of the gesture further include instructions for determining that the receipt of the gesture occurs within a time threshold.

19. The method of claim 1, wherein the method further comprises:
determining a rectangle to surround the gesture received on the display screen based on upper, lower, right and left edges of the gesture; and
fitting the rectangle such that a usable area of the display screen is maximized in an updated display subsequent to the zoom operation.

20. The method of claim 1, wherein the method further comprises:
determining a rectangle to surround the gesture received on the display screen based on an upper, lower, right and left edge of the gesture; and
performing at least one adjustment to the rectangle such that an updated display generated responsive to the zoom operation is proportional to a geometry of the display screen.

21. The apparatus of claim 10, wherein the computer readable instructions further cause the apparatus to:
determine a rectangle to surround the gesture received on the display screen based on an upper, lower, right and left edge of the gesture; and
fit the rectangle such that a usable area of the display screen is maximized in an updated display subsequent to the zoom operation.

22. The apparatus of claim 10, wherein the computer readable instructions further include at least one instruction that, when executed by the processor, cause the apparatus to:
determine a rectangle to surround the gesture received on the display screen based on an upper, lower, right and left edge of the gesture; and
perform at least one adjustment to the rectangle such that an updated display generated responsive to the zoom operation is proportional to a geometry of the display screen.

23. A method comprising:
detecting a pen-down event on a display screen of a computing device, wherein the pen-down event is associated with a beginning point;
responsive to the pen-down event, detecting user input associated with a portion of a gesture;
determining that the portion of the gesture is approximately a circular shape;
rendering an end zone area on the display screen responsive to determining that the portion of the gesture is approximately a circular shape;
receiving a pen-up event, wherein the pen-up event is associated with an end point;
determining whether both the beginning point and end point lie within the end zone area;
determining whether tangents associated with the gesture do not exceed a predetermined threshold; and
performing a zoom operation responsive to determining that both the beginning point and end point lie within the end zone area and that the tangents do not exceed the predetermined threshold.

24. The method of claim 1, wherein the step of receiving a gesture includes rendering an end zone area on the display screen, wherein the end zone area is configured with a back-button to provide for a zoom-out operation.
